(19) United States
(12) Patent Application Publication
(10) Pub. No.: US 2008/0198228 A1
(43) Pub. Date: Aug. 21, 2008

(54) ACTIVE DOOR MONITORING SYSTEM

(76) Inventor: MAGDY A. RIZK, Brossard (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/014,036

(22) Filed: Jan. 14, 2008

Related U.S. Application Data
(60) Provisional application No. 60/880,050, filed on Jan. 12, 2007.

(51) Int. Cl. H04N 7/18

(52) U.S. Cl. 348/148; 348/E05.024

(57) ABSTRACT

There is described a door monitoring system comprising a display device integrated into a door of a vehicle; a camera including image capture circuitry hidden behind the display device; and a control unit in communication with the display device for determining information to be displayed thereon, and with the camera to control the image capture, receive images captured by the camera, and transmit the images via a network

### CROSS-REFERENCE TO RELATED APPLICATIONS

The present application claims priority of US Provisional patent application filed on Jan. 12, 2007 and bearing Ser. No. 60/880,050.

### TECHNICAL FIELD

The present invention relates to the field of trains and other types of public transportation vehicles, and more specifically to security and maintenance issues with respect to these types of vehicles.

### BACKGROUND OF THE INVENTION

With the increased need for assuring the general public of their safety, technology is quickly advancing in order to provide the necessary tools. Face recognition, which is the ability to recognize people by their facial characteristics, is being used in places such as airports to identify potential suspects. Computers can conduct facial database searches and perform live verifications with unprecedented accuracy and split-second processing.

Many cameras are also present in public transportation networks, such as subway stations, train stations, metro stations, etc. However, these cameras are in plain sight, and easily avoidable by someone who is trying to remain unseen.

Therefore, there is a need to provide an improved monitoring system in public areas to increase the chances that authorities may be able to capture the image of a suspect on a camera.

### SUMMARY OF THE INVENTION

There is provided a door monitoring system for capturing images of passengers as they enter and/or exit a public transportation vehicle such as a subway, train, or other. A camera is integrated into a door of the vehicle and hidden such that the camera is not visible to the passenger. The system is capable of real time video monitoring, and may include face recognition capabilities. The information gathered by the system is transmitted through a wireless network to a security center for processing and storing. Audio monitoring may also be available.

The means used to hide the camera, and possibly microphone, is to place it behind a screen. Various images, such as advertising and general announcements, may be displayed on the screen, thereby attracting the attention of a passenger towards the camera and allowing images to be captured inconspicuously.

In accordance with a first broad aspect of the present invention, there is provided a door monitoring system comprising: a display device integrated into a door of a vehicle; a camera including image capture circuitry hidden behind the display device; and a control unit in communication with the display device for determining information to be displayed thereon, and with the camera to control the image capture, receive images captured by the camera, and transmit the images via a network.

In accordance with a second broad aspect of the present invention, there is provided a method for monitoring passengers in a public transportation vehicle, the method comprising: integrating a display device into a door of the vehicle to display information to the passengers; capturing images of passengers using a camera hidden behind the display device in the door; and transmitting the images of the passengers to at least one of a conductor of the vehicle and a security center via a network for processing and storing the images.

While the description will use the term “train”, it should be understood that the active door monitoring system is not limited only to trains per se, but can be integrated into any door of a vehicle.

### BRIEF DESCRIPTION OF THE DRAWINGS

Further features and advantages of the present invention will become apparent from the following detailed description, taken in combination with the appended drawings, in which:

FIG. 1 is a front view of a train door with an integrated screen and camera, in accordance with an embodiment of the present invention;

FIG. 2 is a top view of a train with four cars and their corresponding doors, in accordance with an embodiment of the invention;

FIG. 3 is a block diagram of the active monitoring system in accordance with an embodiment of the invention;

FIG. 4 is a block diagram showing the inside of the control unit in accordance with an embodiment of the present invention;

FIG. 5 illustrates a block diagram comprising a RFID unit according to an embodiment of the invention;

FIG. 6 illustrates a sectional view of a door with a single integrated antenna according to an embodiment;

FIG. 7 illustrates a sectional view of a door having two integrated directional antennas according to an embodiment;

FIG. 8 illustrates a sectional view of another door having two integrated directional antennas according to an embodiment; and

FIG. 9 illustrates a sectional view of a door having four antennas according to an embodiment.

It will be noted that throughout the appended drawings, like features are identified by like reference numerals.

### DETAILED DESCRIPTION

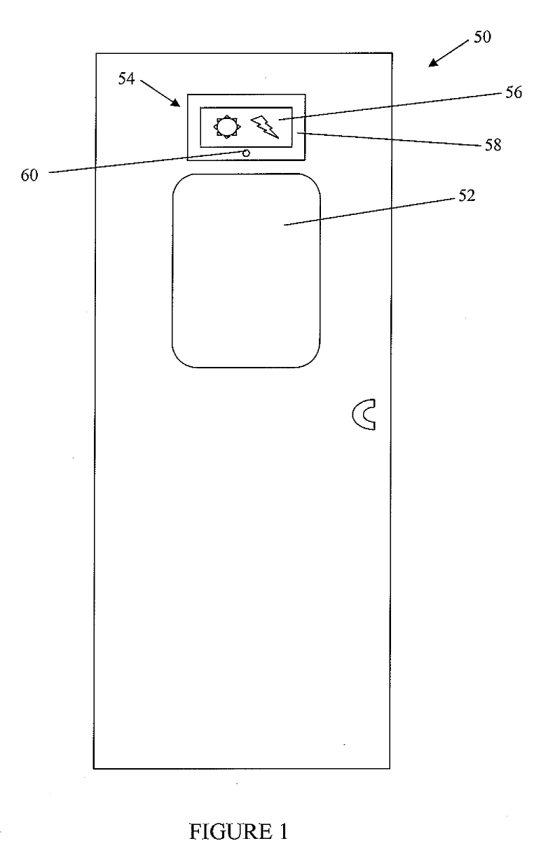

FIG. 1 illustrates one of many possible models for a door 50 in a public transport vehicle such as a train. The window 52, which is of standard size, is made of multiple layers of a plastic sheaf in order to be break-proof. A screen 54 is placed above the window, at approximately eye level for a man of average height. The screen 54 is also covered with the same type of plastic material as the window 52 in order to be tamper-proof. The surface of the screen is flush with the surface of the door 50 such that it is fully integrated therein. The active door monitoring system is completely integrated within the door 50 itself. The door 50 can be manufactured with a hole of appropriate size to receive the screen and its associated electronics. The system can then be placed inside the hole and locked into place using a locking mechanism. Only those having the key for the locking mechanism may remove the system from the door.

The display area 56 of the screen 54 is surrounded by a frame portion 58 which does not include any pixels and on which no image is shown. A pinhole 60 is provided in the frame portion 58 for the lens of the camera. The lens is camouflaged by the frame itself and the material covering the entire screen. The lens of the camera may be very small, such as 4 millimeters in diameter. The lens may be a regular type of lens, or a wide angle lens, in order to have a wider field of view. The camera is provided behind the screen and is therefore not visible to the public.

The screen may be used to display general announcements, such as the news, the weather, or other types of announcements such as technical difficulties being encountered in the transportation network. Information relative to the location of the train may be displayed. For example, a map indicating the route of the train and its location may be displayed. Advertisements may also be provided on the screen. Alternatively, entertainment such as movies or television shows may also be provided on the screen.

The screen may also be used to display information for employees when the train is not in operation. For example, maintenance information may be provided on the screens. The screens can also be used during the training of employees.

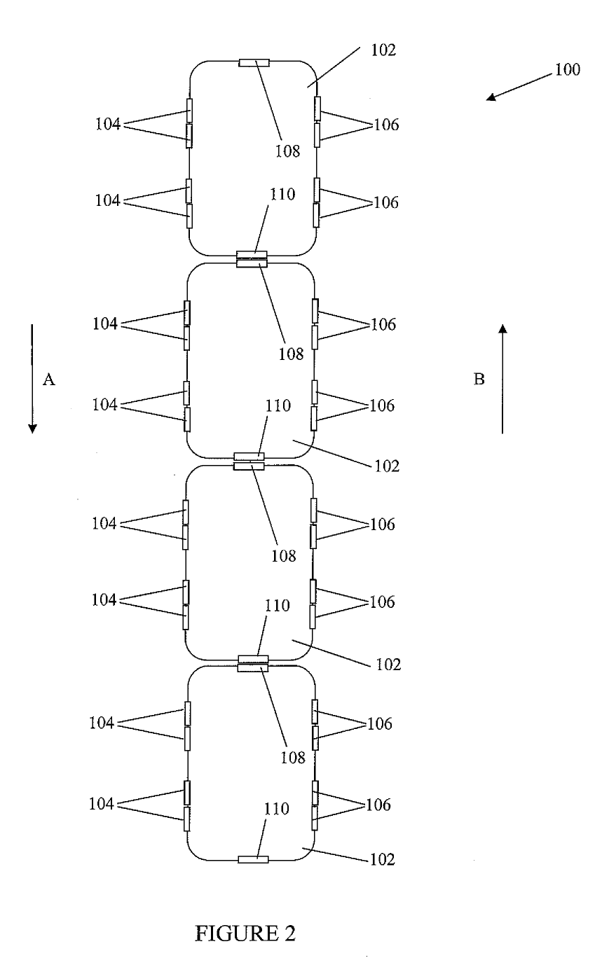

FIG. 2 is a top view of a train 100 including four cars 102. Two sets of two sliding doors 104, 106 are provided on each side of the car. A single end door 108, 110 connects one car to the next. As per convention, when the train is moving in direction A, the doors 102 which open to the passengers are those on side A of the train. When the train is moving in direction B, the doors 104 which open to the passengers are those on side B of the train. All doors on the train may be equipped with the active door monitoring system illustrated in FIG. 1, including the end doors 108 interconnecting the cars together. In this embodiment, each car would have a screen on each side door, for a total of 8, and a screen on the front and back doors. Alternatively, there may be screens on only the side doors, on only one of each set of two side doors, or on only the front and back doors. Also alternatively, the system may also be used in trains that are equipped with only one door instead of two sliding doors, or with sets of two doors that are not facing each other.

In the case where screens are present on at least one side door, the system facing the passengers as they enter the train, i.e. in the door that is not open, is activated to capture frontal images of passengers entering the train. When the train is traveling in the opposite direction, such as when it reaches the end of a line and returns along the same line in the opposite direction, the system in the door on the opposite side of the train would then be activated to again capture frontal images of passengers entering the train. Back images may also be captured of passengers exiting the train. The camera of the system may be active at all times, i.e. capturing images continuously, or may be activated only when the train slows down and comes to a stop.

In one embodiment, the active door monitoring systems located in the end doors act as routers. For example, assuming that the train is moving in the direction B, the active door monitoring system 108 located in the last wagon collects all information from the active door monitoring systems located in the doors 106 and 110 of its wagon. In addition to its own information, this active door monitoring system transmits the collected information to the active area door system of the door 110 of the next wagon which transmits it to the active door monitoring system of the next end door 108. This process continues until all information coming from all active door monitoring systems of the train comes to the conductor. In this embodiment, all information for one train is gathered together. In an alternative embodiment, each wagon transmits independently to a central security system.

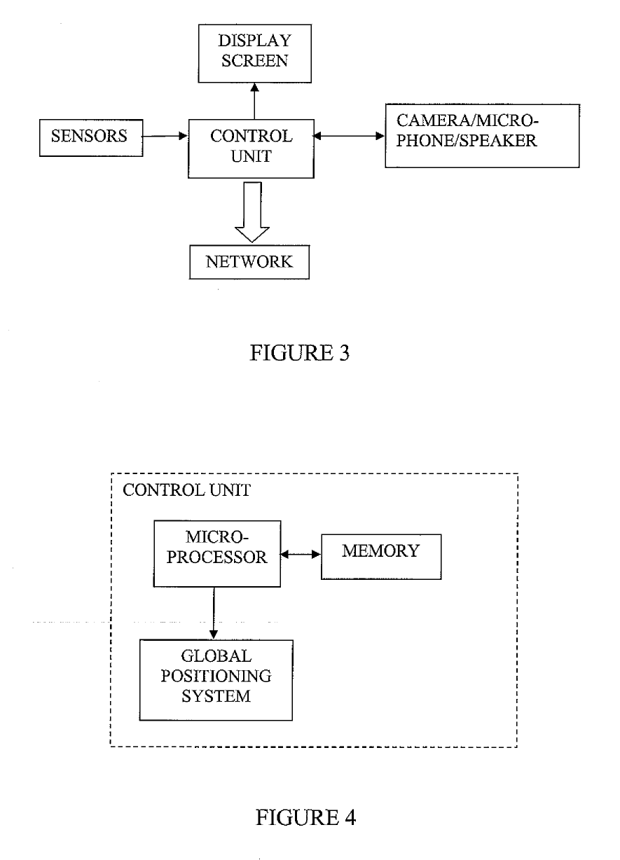

FIG. 3 illustrates some of the hardware present in the active door monitoring system. A control unit is connected to a display and to a camera. The camera captures images, which are sent to the conductor and/or to a security center for processing and storing via a network. The transmission is done in real time and therefore, the system is capable of real time video and audio monitoring, including face recognition. The images presented on the display are not those captured by the camera. However, the system may be used for communication between the operator, conductor, crew, and passengers. For example, if a passenger is preventing a door from closing, the conductor may use the audio capabilities of the system to ask the passenger in the specific car of the train to allow the door to close. Additionally, the conductor may control door opening and closing frequencies depending on the volume of passengers at a given time through a given set of doors. A microphone may also be incorporated in the active door monitoring system to enable the conductor and/or the security center to hear what happens in a particular wagon.

In one embodiment, pictures are sent to the security center while the conductor of the train can see the interior of the wagon via a closed-circuit television (CCTV).

The computer may also be connected to various sensors already present in these types of vehicles, to allow for system monitoring. Examples of information gathered by these sensors are HVAC control, travel speed, destination arrival announcement, embarking and passenger flow, lighting conditions, etc. The system may also be used to provide a more precise door maintenance application, by keeping track and processing door operating cycles, visually inspecting door operation and blockage, and registering operation temperature and friction using sensors to determine wear of the door mechanisms. The system is adapted to determine whether an operation parameter is below or above a threshold and to subsequently send an alarm message to the conductor and/or the security center.

The active door monitoring system is also adapted to receive information from the conductor and/or the security center via the network. Update of the system can then be done.

The system may also be provided with an alarm button that can be used by users to trigger an alarm. An alarm signal is sent to the conductor and/or to the security center via the network. The conductor and/or an agent of the security center can then look at images coming from the wagon where the alarm was triggered and take decisions. The system can be adapted to take a higher number of pictures per unit of time when an alarm is triggered.

In one embodiment, the network is a wireless network based on radio frequency (RF). The information taken by the active door monitoring system is sent to the conductor and/or to the security center via RF signals. Alternatively, the information between the active door monitoring system of a door and the conductor can be transmitted via wires while the communication between the conductor and the active door monitoring system, on one side, and the security center, on the other side, is wireless.

In the case where all communications are wireless, a relay can be located in each wagon. The relay collects the information coming from the different active door monitoring systems of a wagon and communicates it to the conductor and/or the security center.

FIG. 4 illustrates possible components present in the control unit found in FIG. 3. A microprocessor is present to perform all logic functions necessary. The size and power of the microprocessor will vary depending on the specific needs of the system. A memory may also be present, also varying in size depending on system requirements. A global positioning system (GPS) may be present in the system in order to track the position of the train at all times. Alternatively, only one active door monitoring system in the wagon or in the train may be provided with a GPS. It should be understood that any system allowing the tracking of the train may be used in replacement of the GPS.

In one embodiment, the pictures or film and the sound taken by the system are stored in the memory. Additionally, the system can also store in memory all information about the wagon provided by the different sensors such as the temperature, humidity, electrical sensors etc.

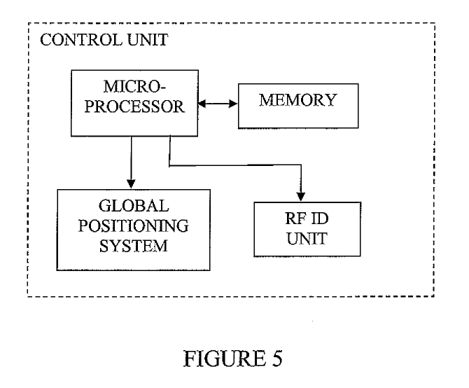

FIG. 5 illustrates another embodiment of the control unit. In this embodiment, the control unit further comprises a radio frequency identification (RFID) unit. This unit may be used in conjunction with train tickets and/or cards containing RFID tracking devices such as tags. The path of a passenger holding a ticket with an RFID tracking device can be traced using the RFID unit. In additions images of the passengers in the train may be linked to the RFID tracking device to help authorities narrow down a possible list of suspects. The RFID of users can be used for statistical purposes. Using the tags and the RFID, it may be possible to determine the number of users of a train line.

The identification using tags also allows the reduction of fraud. For example, a user buys a train ticket to go from a first location to a second location but stays on the train instead of getting off the train at the second location. The RFID notices that the user is still on the train and informs the conductor of the train. A train controller can then locate the individual.

Employees can also be provided with an employee card having a tag. This card can be used as an identification card and/or an access card and can also be used to locate an employee.

The RFID unit comprises an antenna to read the tag associated with a ticket and/or card. In the case where the active door monitoring system is already provided with an antenna for communication purposes, the reading of the tags may be performed by this antenna. Alternatively, the system may be provided with two antennas, one for communication and the other one for RFID.

As for the transmission of the visual and sound information, the information relative to the tags can be collected in a single piece of equipment such as a RFID scanner. The train can be provided with a single scanner. Alternatively, each wagon of the train may be provided with a scanner. The information gathered at the scanner(s) is then transmitted to the conductor and/or the security center via the network used for the visual and sound information.

While a single antenna may be used to receive and transmit information, two antennas can be used, one for reception of information and the other one for transmission.

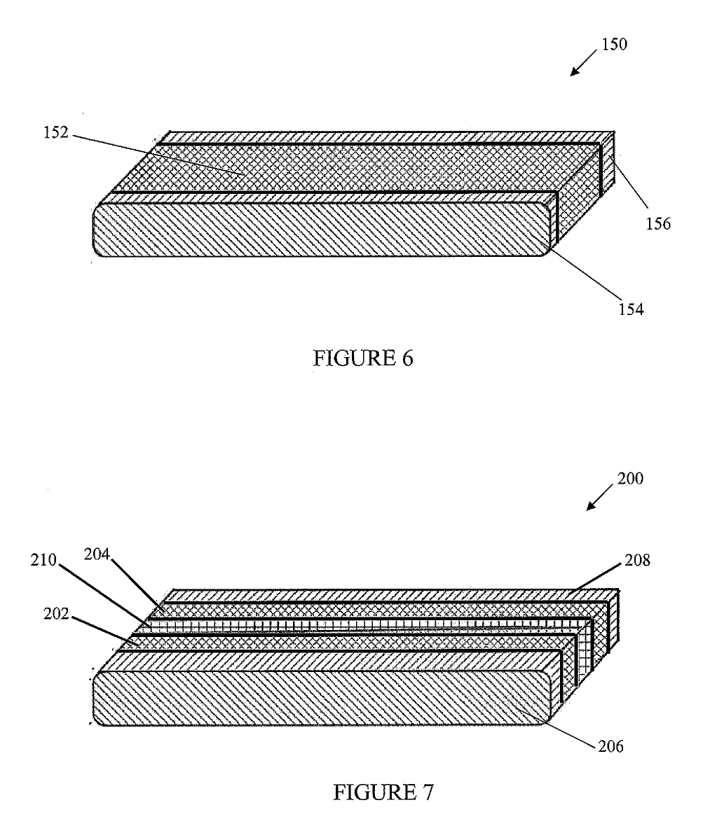

In one embodiment, the antenna used for RFID is integrated inside the door. FIG. 6 illustrates one embodiment of a door 150 with an integrated antenna 152. The antenna 152 is sandwiched between the front panel 154 and the rear panel 156 of the door 150. The antenna 152 is bi-directional so that it can receive and emit signals coming from both panel sides.

FIG. 7 illustrates a door 200 having two integrated antennas 202 and 204 according to one embodiment. Both antennas are located between a front panel 206 and a rear panel 208 of the door 200 and a layer 210 of a solid material maintains the different pieces in position. For example, the layer 210 can be made of a honeycomb material. The antennas 202 and 204 are uni-directional so that antenna 202 can only receive and transmit signals in the direction of the front panel 206 and antenna 204 receives and transmits signals in the direction of the rear panel 208. Using two uni-directional antennas enables to know on which side of the door a person holding a tag is.

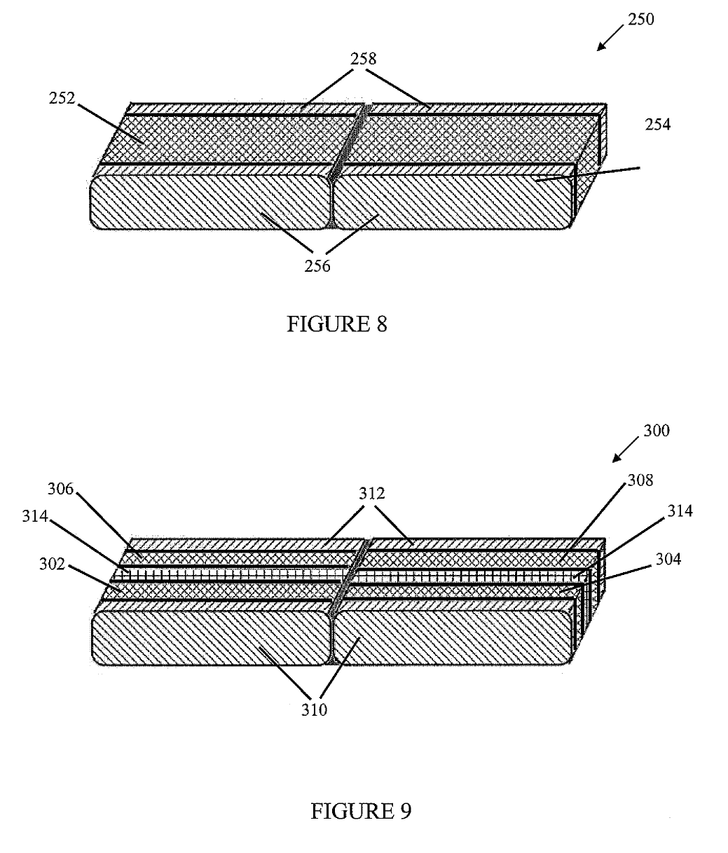

FIG. 8 illustrates a door 250 having two integrated and uni-directional antennas 252 and 254 according to another embodiment. The antennas 252 and 254 are sandwiched between the front panel 256 and the rear panel 258 of the door 250. While the antenna 252 can receive and emit signal in the direction of the front panel 256, the antenna 254 receives and emits signals in the direction of the rear panel 258.

FIG. 9 illustrates a door 300 having four integrated and uni-directional antennas 302, 304, 306, and 308 according to one embodiment. Antennas 302, 304, 306, and 308 are located between a front panel 310 and a rear panel 312 of the door 300. A layer 314 is located between antennas 302, 304, on one hand, and antennas 306, 308, on the other hand. While antenna 302 is used to emit signals in the direction of the front panel 310, antenna 30 is used to receive signals from the same direction. Antenna 306 is used to emit signals in the direction of the rear panel 312 and antenna 308 receives signals coming from the rear panel 312.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

In one embodiment, the communication between the active door monitoring systems, the conductor and the security center is continuous in time. Alternatively, the communication can happen at specific time. The communication between the train and the external environment can be dependent on the speed of the train. For example, the communication between the active door monitoring systems and/or the conductor, and the security center happens when the speed of the train is below a threshold. In this case, the communication can occur when the train slows down while entering a station or when the train accelerating while leaving a station. Alternatively, the communication may occur at specific location along the train's path.

In one embodiment, all information exchanged between the active door monitoring systems, the conductor and the security center is encrypted for security purposes. Any encryption technique known by a person skilled in the art can be used.

The embodiments of the invention described above are intended to be exemplary only. The scope of the invention is therefore intended to be limited solely by the scope of the appended claims.

1. A door monitoring system comprising:
a display device integrated into a door of a vehicle;
a camera including image capture circuitry hidden behind said display device; and
a control unit in communication with said display device for determining information to be displayed thereon, and with said camera to control said image capture, receive images captured by said camera, and transmit said images via a network.

2. A door monitoring system as claimed in claim 1, wherein a lens of said camera is provided in a frame portion of said display device surrounding an active screen portion, and said camera captures said images above said active screen portion.

3. A door monitoring system as claimed in claim 1, further comprising a microphone hidden behind said display device to obtain audio data, wherein said audio data is also transmitted via said network.

4. A door monitoring system as claimed in claim 1, wherein said control unit is connected to at least one sensor in said door, and is adapted to gather sensor data.

5. A door monitoring system as claimed in claim 4, wherein said sensor data is at least one of temperature, speed, friction, and passenger flow through said door.

6. A door monitoring system as claimed in claim 1, wherein said control unit causes said image capture circuitry to be activated when said vehicle decelerates, and to be deactivated when said vehicle accelerates.

7. A door monitoring system as claimed in claim 1, wherein said control unit causes said images to be transmitted via said network when said vehicle is immobilized.

8. A door monitoring system as claimed in claim 1, further comprising a lock mechanism to secure said system within said door and allow only authorized personnel access.

9. A door monitoring system as claimed in claim 1, wherein said control unit comprises a global positioning system to locate a geographical position of said vehicle when it is traveling.

10. A door monitoring system as claimed in claim 1, wherein said control unit comprises a radio frequency identification unit to detect radio frequency tracking devices embedded in tickets carried by said passengers.

11. A door monitoring system as claimed in claim 1, further comprising a speaker in communication with said control unit.

12. A door monitoring system as claimed in claim 1, wherein said control unit comprises a facial recognition module to perform facial recognition on images captured by said camera.

13. A door monitoring system as claimed in claim 1, wherein said network is wireless.

14. A method for monitoring passengers in a public transportation vehicle, the method comprising:
integrating a display device into a door of said vehicle to display information to said passengers;
capturing images of passengers using a camera hidden behind said display device in said door; and
transmitting said images of said passengers to at least one of a conductor of said vehicle and a security center via a network for processing and storing said images.

15. A method as claimed in claim 14, wherein said providing a camera comprises providing a microphone to also obtain audio data, and said transmitting comprises transmitting said audio data via said network.

16. A method as claimed in claim 14, further comprising passing said images through a facial recognition application.

17. A method as claimed in claim 14, wherein said capturing images comprises controlling said camera to capture images as said vehicle is decelerating and stopped, and deactivating said camera when said vehicle is accelerating and advancing at a steady speed.

18. A method as claimed in claim 14, wherein said transmitting comprises transmitting said images continuously.

19. A method as claimed in claim 14, further comprising providing audio capabilities with said display device to allow said conductor to communicate with said passengers in said vehicle.

20. A method as claimed in claim 14, further comprising providing a radio frequency identification unit with said display device to detect radio frequency tracking devices embedded in tickets carried by said passengers.

21. A method as claimed in claim 14, further comprising providing a global positioning system with said display device to determine a geographical position of said vehicle when it is traveling.

22. A method as claimed in claim 14, wherein said transmitting said images comprises transmitting via a wireless network.
